(19) United States
(12) Patent Application Publication
(10) Pub. No.: US 2019/0075796 A1
(43) Pub. Date: Mar. 14, 2019

(54) Increased walnut yields with brassinosteroid application

(71) Applicant: Naga Bhushan Mandava, Potoma, MD (US)

(72) Inventor: Naga Bhushan Mandava, Potoma, MD (US)

(21) Appl. No.: 15/938,469

(22) Filed: Mar. 28, 2018

Related U.S. Application Data
(60) Provisional application No. 62/557,189, filed on Sep. 12, 2017.

(51) Int. Cl. A01N 43/22; A01N 47/36

(52) U.S. Cl. CPC A01N 43/22; A01N 47/36

(57) ABSTRACT

Methods and materials for producing walnuts with improved characteristics including: increased whole nut size, kernel size, shell size and hull size, and increased fruit set are disclosed.

Treatments with 28-homobrassinolide (HBR) and in some cases, HBR with forchlorofenuron (CPPU), increase walnut whole nut size, kernel size, shell size, hull size, and fruit set in Serr and Chandler walnuts. Additionally HBR affects the pollen tube growth rate and germination percentages which may relate to increased fruit set and size. Presumably the increases are related to the effect of HBR on pollen load, and possibly also with embryonic development and stimulation of cell division.

These results can be generalized to additional PGRs: epi-BL, CA, and HCS and mixtures thereof with CPPU. Increase in fruit set or seed size are both factors that directly correspond to higher yields; making these PGRs effective treatments for increasing walnut crop yield and ultimately walnut crop profitability.

### FIELD OF THE INVENTION

The subject matter of this application pertains to a method for using Plant Growth Regulators (PGRs) to produce walnuts with improved characteristics including: increased whole nut size, kernel size, shell size and hull size, and increased fruit set. More precisely, the subject matter of this application pertains to methods for using homobrassinolide (“HBR” CAS #80483-89-2) alone and in combination with Forchlorfenuron (“CPPU” CAS #68157-60-8) to produce walnuts with said improved characteristics.

### BACKGROUND

Commonly, “walnut” refers to the white to brown colored, fleshy inner seed of the walnut tree nut. There are various types of walnut trees producing different types of walnuts including: Serr, Chandler, Tulare, Vina, Sunland, Solano, Howard among others. Serr and Chandler Walnuts account for approximately 90% of the walnut production in the walnut producing regions of Chile. The Serr walnut has several traits desired by growers and buyers. The edible portion is comparatively large with 55% kernel fill, and 70% to 80% of nuts are classified as “extra-clear” in color, an indicator of quality. The fruit is highly resistant to sunburn, which can otherwise damage and shrivel the crop, and it produces 55 to 60 percent fruitful lateral buds. The Chandler walnut also has several desired traits: it is large with 49 percent kernel fill, the shells are round and soft, 90% to 100% of nuts are classified as extra-clear in color, and it produces 90 percent fruitful lateral buds.

Walnuts are produced commercially in walnut tree orchards. Profitability of walnut crops is subject to demand and the costs of production. A most straightforward approach to increasing walnut profitability is to increase the crop yield. In addition to conventional cultivation methods and methods of optimizing growing conditions, the use of PGRs to increase fruit set and size of the kernels may be economically advantageous. As used in this application, “kernel,” “nut,” and “walnut” all refer to the edible kernel of the walnut tree.

In walnuts and other fruit crops, fruit set occurs following pollination and fertilization of the ovules within the flowers, generally culminating in the development of a fruit from an ovary. Developmental processes in seeds and fruit are principally controlled by growth regulators (Pandolfini T. Seedless fruit production by hormonal regulation of fruit set. Nutrients 2009; 1:168-177). Currently, it is accepted that both fruit set and fruit development are regulated by the coordinated action of hormones produced in the ovary after pollination or fertilization (Mariotti et al., Fruit set and early fruit growth in tomato are associated with increases in indole acetic acid, cytokinin, and bioactive gibberellin contents. J Plant Growth Regulator 2011; 30:405-415).

Walnuts are a fruit whose productivity depends on the proportion of fruit set, usually in limiting weather conditions or difficulties in the management of the pollen. In fruit crops, once pollination and fertilization of the ovules within the flowers have taken place, fruit set occurs, generally with development of a fruit from an ovary.

Brassinosteroids are important PGRs that have wide distribution throughout the plant kingdom and unique growth promoting activity when applied exogenously (Mandava, Plant growth-promoting brassinosteroids. Annual Review of Plant Physiology and Plant Molecular Biology 1988, 39, 23-52.) and brassinosteroids have been shown to increase yields and improve stress resistance of several major crop plants (Cutler, et al. Brassinosteroids: chemistry bioactivity, and applications. ACS symposium Series 474. Washington, D.C. 1991; American Chemical Society).

Brassinolide (BL, FIG. 1) was the first brassinosteroid to be synthesized and since then several analogues have been developed including epibrassinolide (epi-BL, FIG. 2), homobrassinolide (HBR, FIG. 3), castasterone (CS, FIG. 6), and homocasterone (HCS, FIG. 7). These brassinosteroids are known by those in the relevant arts to exert similar effects.

Brassinosteroid treatment can be an effective means of increasing yields in many crops even in drought, extreme temperature, or improper soil salinity conditions. Brassinosteroids work with auxin to regulate pollen elongation for pollen tube formation, vascular differentiation, the acceleration of senescence in dying tissue cultured cells, cell expansion and elongation, and provide some protection to plants suffering from chilling, salt, oxidative, heavy metal, pathogen and drought stress.

Other PGRs such as gibberellic acid and forchlorfenuron are also effective at influencing plant growth. Gibberellic acid (“GA₃” CAS #77-06-5, FIG. 4) promotes growth and elongation of cells and stimulates plant growth when used in small amounts. Forchlorfenuron (“CPPU”, FIG. 5) is another plant growth regulator which can improve fruit size and fruit set of blueberries, grapes, and kiwi. https://www.epa.gov/sites/production/files/2015-04/documents/exhibit_e.pdf

The developmental processes of commercially produced seeds and fruit are principally controlled by growth regulators (Pandolfini T. Seedless fruit production by hormonal regulation of fruit set. Nutrients 2009; 1:168-177.). In recent years, the biological efficiency and action mechanisms of several different PGRs on plant physiology and function have been studied. The plant bioregulators (e.g., auxins, gibberellins, cytokinins, and brassinosteroids) have multifunctional effects, low toxicity, and are characterized by having no negative impacts on the environment.

Methods of increasing walnut fruit set and nut size can result in a higher return on investment for growers.

### SUMMARY

The subject matter of this application pertains to plant growth regulators and methods of using such plant growth regulators to affect morphological features of nuts including whole nut weight, kernel weight, and unshelled nut weight. The subject matter of this application further pertains to the use of plant growth regulators, particularly the brassinosteroids, to increase walnut tree fruit set and nut size by applying said plant growth regulators to the trees during critical fertilization periods.

More specifically the subject matter of this application pertains to methods of increasing walnut yield by the application of homobrassinolide alone or in combination with forchlorfenuron, at certain developmental points in the tree's reproductive cycle.

### BRIEF DESCRIPTION OF THE FIGURES

FIG. 1 is an illustration of brassinolide.

FIG. 2 is an illustration of epibrassinolide.

FIG. 3 is an illustration of homobrassinolide.

FIG. 4 is an illustration of gibberellic acid.

FIG. 5 is an illustration of forchlorfenuron.

FIG. 6 is an illustration of castasterone.

FIG. 7 is an illustration of homocastasterone.

FIG. 8 is a table showing the results of four experimental and one control conditions on fruit set percentage, shelled nut weight, and whole nut weight in Serr walnut trees.

FIG. 9 is a table showing the results of four experimental and one control conditions on fruit set percentage, shelled nut weight, and whole nut weight in Chandler walnut trees.

FIG. 10 is a table showing the results of four experimental and one control conditions on germination percentage and pollen tube growth.

FIG. 11 is a 20× photomicrograph of germinating Chandler pollen grains.

FIG. 12 is a flowchart illustrating a way to use the subject matter of this application.

### DETAILED DESCRIPTION

The following description and referenced drawings illustrate embodiments of the application's subject matter. They are not intended to limit the scope. Those familiar with the art will recognize that other embodiments of the disclosed method are possible. All such alternative embodiments should be considered within the scope of the application's claims.

Brassinosteroids are known to enhance both cell division and cell elongation; elicit profound physiological responses at submicromolar concentrations; interact synergistically with other PGRs; elicit responses mostly in meristematic tissues; and control the growth and development of crops in a tissue specific and organ specific manner.

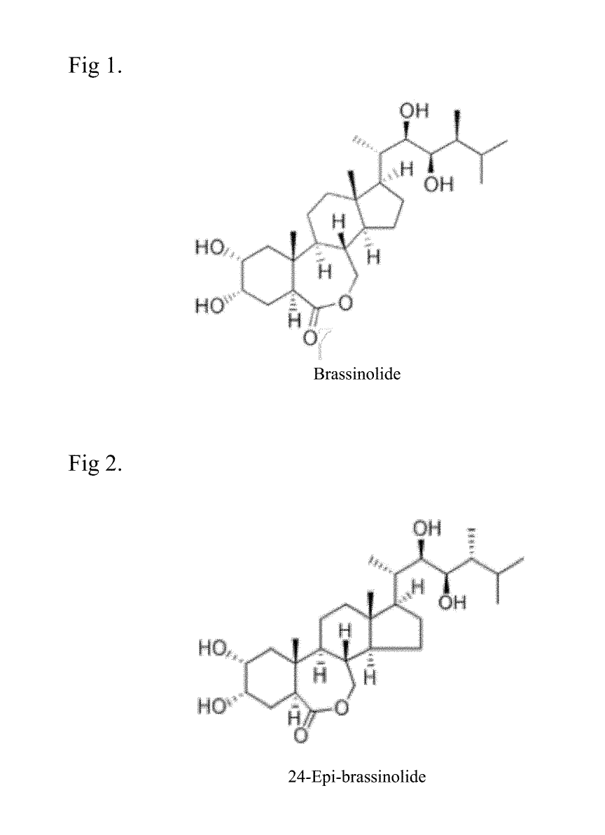

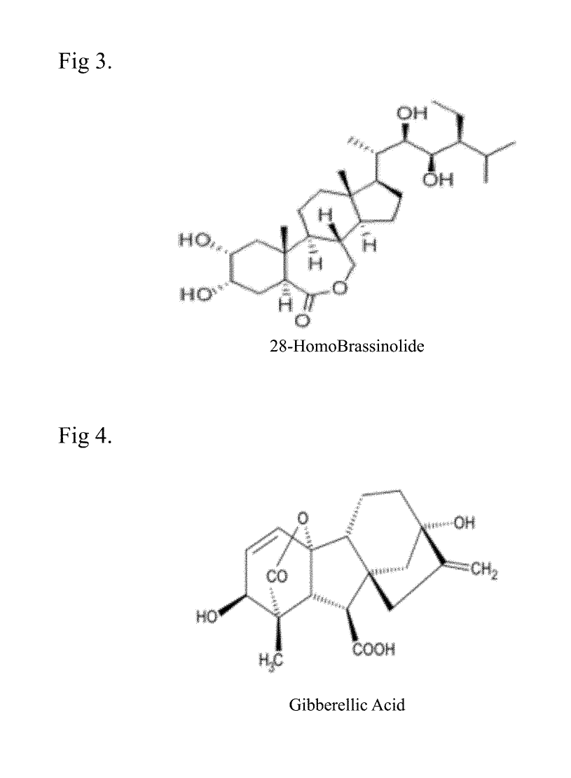

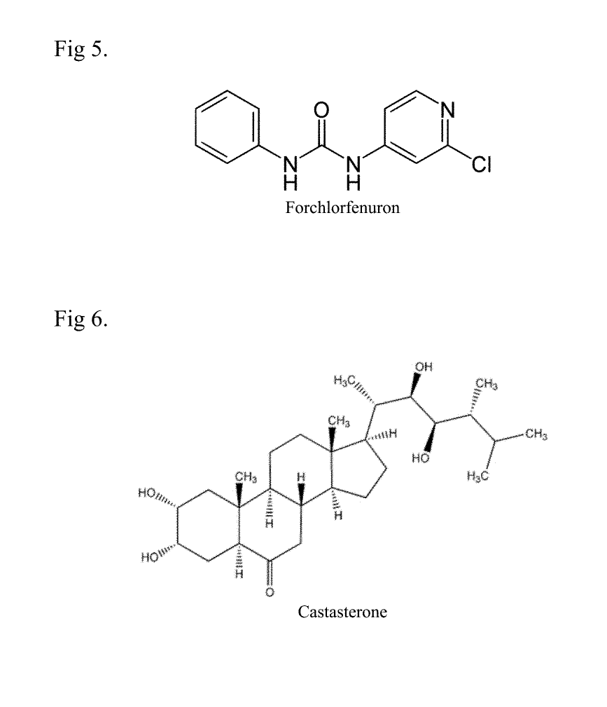

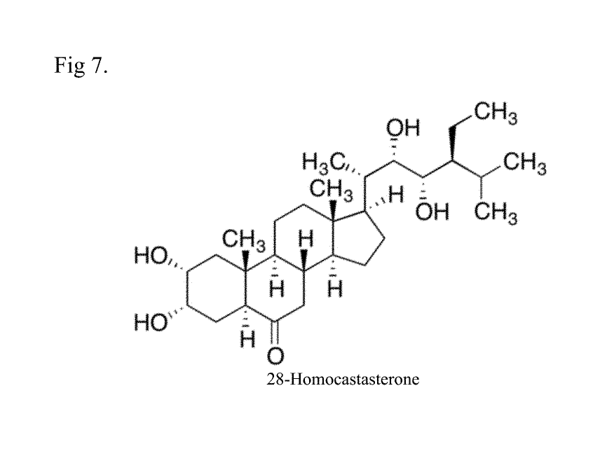

Applications of HBR and HBR with CPPU were made in two contiguous walnut orchards located in Pirque, Metropolitan Region of Chile. The first orchard is of cultivar (“cv.”) Serr, and the second one is of cv. Chandler. Treatment types were identical in each orchard/cultivar and the results of these treatments in terms of fruit set, shelled nut weight, and whole nut weight are given in Table 1 (FIG. 1) and Table 2 (FIG. 2) for Serr and Chandler respectively. In vitro treatment of cv. Chandler pollen was conducted in a laboratory. It should be noted that it was very difficult to gather pollen from the Serr cultivar because flowering was very irregular and it would not germinate in the laboratory. Treatment types were identical to those sprayed in the orchard and results of these treatments are given in terms of germination and pollen tube growth in Table 3 (FIG. 3).

Study 1:

Testing was conducted in two contiguous walnut orchards located in Pirque, Metropolitan Region of Chile. The first orchard is of cultivar Serr, planted at 11×11 m and 20 years old. The second orchard is of cultivar Chandler, planted at 7×6 m and 5 years old. In the 2014/2015 season yield of cultivar Serr was 4,300 kilograms of walnuts in shells per hectare, and in cultivar Chandler the yield was 2,300 kilograms of walnuts in shells per hectare.

During the 2014/2015 season, four experimental and one control treatments were applied to the Pirque orchard. Treatments were foliar sprays with solutions of Homobrassinolide (HBR) at 0.4, 4.0 and 20 ppm, and HBR 4.0 ppm+CPPU 10 ppm. Control was water. Treatment of each cultivar took place 10 days after said cultivar reached approximately 10% pistillate flower receptive. Each tree was sprayed with approximately 250 ml of solution. At that volume the sprayed leaves and branches are wetted and excess solution is dripping off the tree. Applications were made to small branches having 2 to 4 terminal buds with pistillate flowers, equivalent to 3 to 12 potential fruits per replication. The experimental design was randomized blocks with 10 replications. Ten trees per cultivar received treatment and all treatments were applied to separate spray targets of each tree. The spray targets included pistillate flowers, catkins and leaves.

Walnut flowering of both cultivars in the season was prolonged and irregular, extending for 2 weeks in each cultivar. Bloom was mainly protandrous with catkins fall of 20-30% during the pistillate flowering period for both cultivars. The vegetative growth was normal. When flowering of cv. Serr reached 10 to 20% of receptivity, Aminoethoxy vinyl-glycine was applied at a concentration of 125 ppm to all conditions to delay ripening.

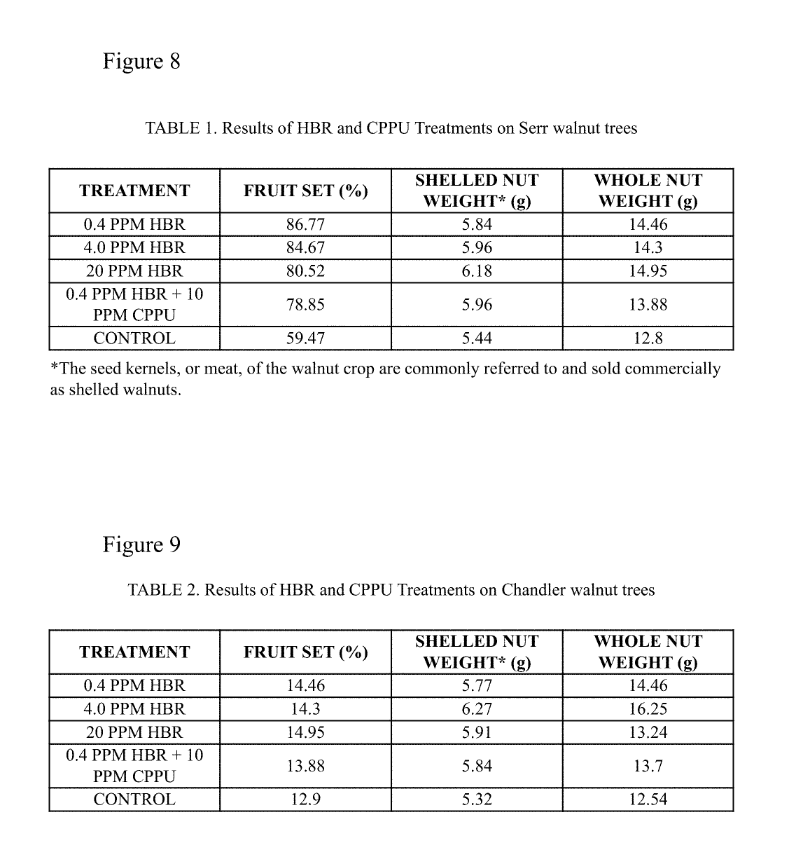

The measurement of fruit set was determined by the difference between the number of fruit harvested and the number of flowers/fruitlets sprayed in late flowering. After harvest, the nuts from the experiment were dried in laboratory at a temperature of 35° C. for 12 hours, and then the nut shell was removed, measuring the weight of both (in shell and shelled) independently. This data is summarized in Tables 1 and 2 (FIGS. 8 and 9).

Fruit set in cv. Serr was greater with all treatment of HBR than control. The increase in fruit set in the experimental treatment groups were between 32.4% and 45.9% greater than control. The final weight of Serr walnuts in shell proved to be significantly higher with all treatments of HBR, except HBR with CPPU which was similar to control. The increase in weight was from 11.7% to 16.4% relative to control. The final weights of shelled Serr walnuts were greater than control for all treatments of HBR, except HBR 0.4 ppm

Fruit set in cv. Chandler was greatest following treatment of HBR 20 ppm (13.5% increase). Treatments with HBR 0.4 ppm, HBR 4.0 ppm and HBR 4.0 ppm+CPPU 10 ppm were intermediate (6.2, 5.0 and 5.8% increase respect to the control The final weight of Chandler walnuts shelled increased as compared with control with all treatments of HBR, except HBR 0.4 ppm which was similar to control. The increase in weight was from 8.4 to 17.8% relative to control. Combining the factors of fruit set and shelled seed weight, we have determined the best treatment for Serr and Chandler walnut was 0.4 ppm and 4.0 ppm HBR respectively.

The final weights of Chandler walnuts in shell were greater than control in the HBR 4.0 ppm and the HBR 20 ppm conditions (16.9% and 29.6% increase respectively) while the weights of the HBR 20 ppm and HBR 4.0 ppm+CPPU 10 ppm conditions were similar to the control.

The percentage growth of fruit set is greater than control for both cultivars following all experimental treatments, and was greater for Serr walnut cultivars than the Chandler variety. While the exact reason for this difference in percentage fruit set between cultivars is unknown, the degree of some physiological responses to PGRs can vary between different varieties of a species. (Gokbayrak, Z.; Engin, H. Effect of plant growth regulators on in vitro pollen germination of grapevine cultivars. Acta Hortic. 2016, 1139, 405-408).

Study 2:

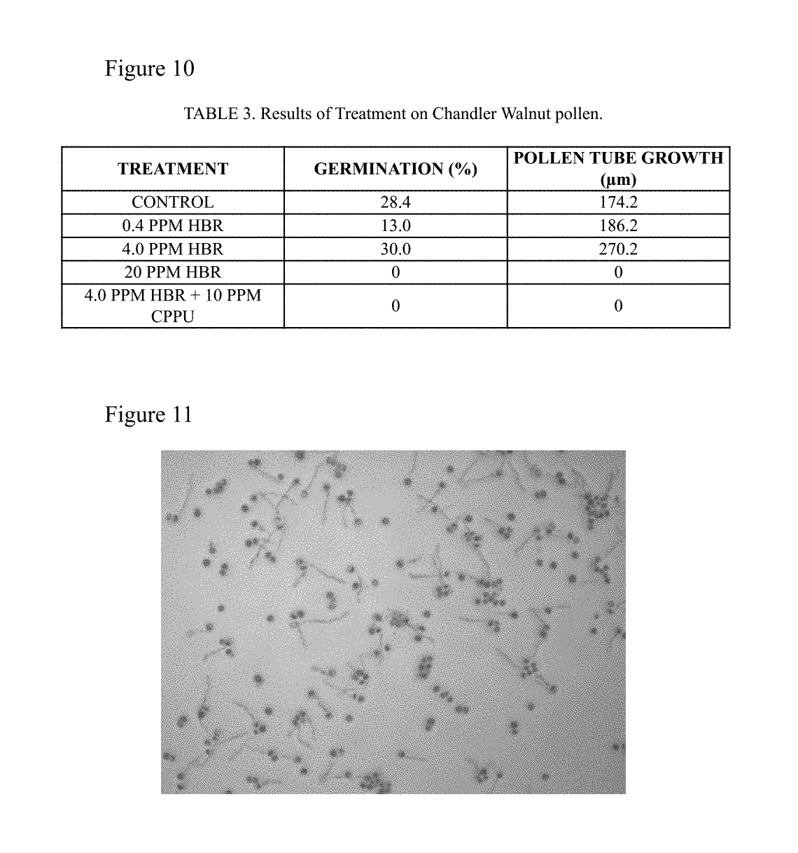

An in vitro experiment was done to study the effects of the same treatments as Study 1 on pollen of cv. Chandler. The growing media used for pollen germination and tube growth was prepared in Petri dishes, and consisted of a solution of 10% sucrose and 1% agar in 50 mg per liter boric acid, plus either 0.4 ppm HBR, 4.0 ppm HBR, 20 ppm HBR, or 4.0 ppm HBR+10 pm CPPU. The control solution was distilled water. The data is summarized in Table 3 (FIG. 10).

The experimental design was randomized with 4 replications, using Petri dishes as experimental units. Chandler pollen was sown onto the media with a fine brush, and incubated in a growth chamber for 24 hours at 20° C. Observations of pollen germination were done after 12 hours and pollen tube growth after 24 hours respectively. An Olympus CX31 microscope at 40× was used, and photographs were taken with a ProgRes® C3 camera, using the Capture-Pro computational program. The percentage of germination was determined using the GSA Image Analyzer 3.6.5 program, and the pollen tube length with the Qcad program. FIG. 11 is a representative 20× photomicrograph of germinating Chandler pollen.

Germination of cv. Chandler pollen in the control and similar to treatment with 4.0 ppm HBR. Germination in the 0.4 ppm HBR group was less than control. In the 20 ppm and 4.0 ppm HBR+10 ppm CPPU conditions there was no germination. Pollen tube growth was greater than control in the 4.0 ppm HBR treatment group.

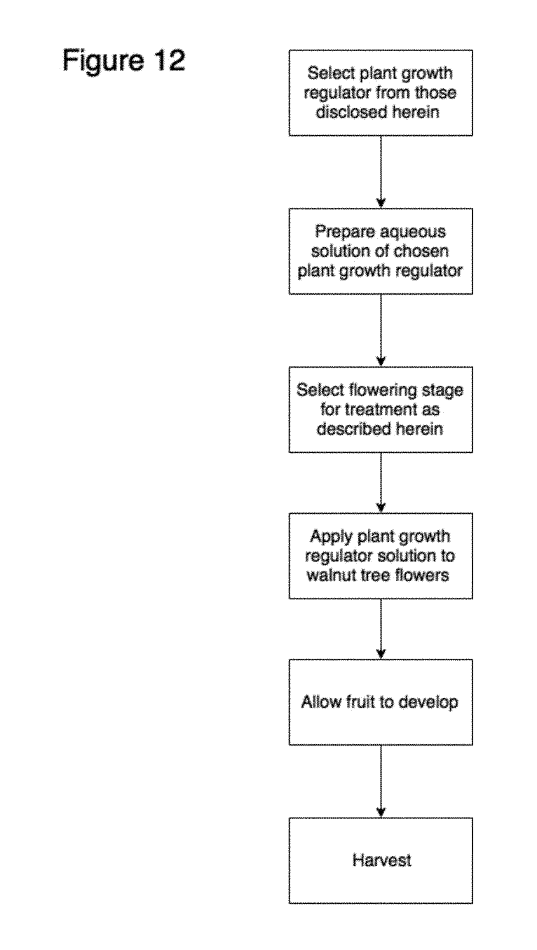

To use the subject matter of this application, one would select an appropriate plant growth regulator from those disclosed and prepare a solution containing the selected plant growth regulator at the desired concentration as discussed herein. Said solution is then sprayed at the walnut tree flowers at an appropriate flowering stage and the fruit is allowed to develop normally until harvest. FIG. 12.

1. A solution for increasing the mass of edible seeds from a walnut tree comprising a plant growth regulator selected from the group consisting of 28-Homobrassinolide, Brassinolide, 24-epibrassinolide, Gibberellic acid, Castasterone, and 28-Homocastasterone.

2. The solution of claim 1 further comprising forchlorfenuron.

3. The solution of claim 1 in which the concentration the plant growth regulator is between approximately 0.4 ppm and 20 ppm.

4. The solution of claim 1 further comprising approximately 10 ppm forchlorfenuron.

5. A method for increasing the mass of edible seeds harvested from a walnut tree comprising the steps of applying a aqueous solution of a plant growth regulator selected from the group consisting of Homobrassinolide, Brassinolide, Epibrassinolide, Gibberellic acid, Castasterone, and Homocastasterone to the flowers of a walnut tree at a determined time during flowering.

6. The method of claim 5 in which the aqueous solution is comprised of between 0.4 ppm and 20 ppm Homobrassinolide.

7. The method of claim 5 further comprising the steps of preparing said plant growth regulator solution by diluting a concentrated plant growth regulator solution to the desired final concentration, allowing the edible seeds to grow to maturity following application of the aqueous plant growth regulator solution, and harvesting the mature nuts.

8. The method of claim 5 in which the determined time during flowering is the pre-bloom growth stage.

9. The method of claim 5 in which the determined time during flowering is the full-bloom growth stage.

10. The method of claim 5 in which the determined time during flowering is the post-bloom growth stage.

11. The method of claim 5 in which the aqueous solution further comprises 10 ppm forchlorfenuron.
